(19) United States
(12) Patent Application Publication
(10) Pub. No.: US 2023/0150256 A1
(43) Pub. Date: May 18, 2023

(54) METHOD OF CREATING A PRINTED PRODUCT

(71) Applicant: Heidelberger Druckmaschinen AG, Heidelberg (DE)

(72) Inventors: Jochen Pecht, Ketsch (DE); Martin Schmitt-Lewen, Heidelberg (DE)

(21) Appl. No.: 17/987,091

(22) Filed: Nov. 15, 2022

(30) Foreign Application Priority Data
Nov. 17, 2021 (DE) 10 2021 129 952.7

(51) Int. Cl. B41F 31/08; B41F 31/04; B41F 31/20; B41F 23/04

(52) U.S. Cl. CPC B41F 31/08; B41F 23/04; B41F 31/04; B41F 31/20

(57) ABSTRACT

A method for creating a printed product includes providing a printing substrate, providing a first fluid, applying the first fluid to the printing substrate as a first layer, providing an effect fluid as a second fluid, the effect fluid including a carrier fluid and platelet-shaped effect pigments, and applying the effect fluid to the printing substrate as a second layer, the second layer forming an effect layer. The first layer is created as a duct layer having a multiplicity of ducts. The ducts allow at least a portion of the carrier fluid of the effect fluid to pass through or enter, and the ducts substantially do not allow the effect pigments of the effect fluid to pass through or enter. This provides a cost-efficient and advantageous way of creating high-quality printed products with top quality finish and special effects having improved impact of the special effects.

### CROSS-REFERENCE TO RELATED APPLICATION

This application claims the priority, under 35 U.S.C. § 119, of German Patent Application DE 10 2021 129 952.7, filed Nov. 17, 2021; the prior application is herewith incorporated by reference in its entirety.

### FIELD AND BACKGROUND OF THE INVENTION

The invention relates to a method of creating a printed product including the steps of:
providing a printing substrate,
providing a first fluid and applying the first fluid to the printing substrate as a first layer,
providing an effect fluid as a second fluid, the effect fluid including a carrier fluid and platelet-shaped effect pigments, and applying the effect fluid to the printing substrate as a second layer, the second layer forming an effect layer.

The technical field of the invention is the field of the graphics industry, in particular the field of finishing printed products or creating printed products with a high-quality finish, i.e. high-quality printed products. In particular, the invention is in the field of creating printed products with special effects such as gloss.

### DESCRIPTION OF THE RELATED ART

Printing inks and varnishes that contain effect pigments are known in the art. A basic distinction is made between leafing pigments and non-leafing pigments. In general, printing inks and printing varnishes with leafing pigments are considered to be the class of pigments with the most appealing optical metallic effect. For instance, silver-colored printing varnishes with leafing pigments on the basis of aluminum are popular. Such leafing pigments are, for instance, described in Standard No. DIN 55923 by the German Institute for Standardization. Although printing inks and printing varnishes on the basis of non-leafing pigments are common, too, they tend to have an optically less appealing metallic effect and frequently have a matte or grayish appearance.

Layers with leafing pigments created in that way usually need a protective varnish coating because otherwise the pigments located on the surface would easily rub off and the desired effect would quickly be lost (cf. FIGS. 1A to 1C).

The as yet unpublished German Patent Application DE102021125055 thus discloses a method of creating a coating which includes at least one colorant that accumulates on border surfaces, the method including the steps of i) providing a curable liquid medium including at least one colorant accumulating on border surfaces, ii) applying the curable liquid medium to a carrier, the colorant that accumulates on border surfaces accumulating at the border surface of curable liquid medium and surrounding atmosphere, iii) at least partly curing the curable liquid medium on the carrier and iv) transferring the curable liquid medium which has at least partly been cured from the carrier to a substrate in such a way that the side on which the colorant that accumulates on border surfaces has accumulated on the carrier rests on the substrate. That method provides an efficient way of creating mechanically rugged coatings with leafing pigments without requiring a protective varnish.

For non-metallic effect pigments (iriodine and related pigments of the interference class of pigments), on the other hand, there are frequently only non-leafing pigment types available for which there are no improved techniques known. Thus, in that context, the rule in general is “the more the better,” i.e. to improve the pigment effect, thicker layers are applied, in flexographic printing for instance by using anilox rollers that take up larger volumes of ink or in screen printing by using wide-meshed screens. However, such methods are expensive.

### SUMMARY OF THE INVENTION

It is accordingly an object of the invention to provide a method of creating a printed product, which overcomes the hereinafore-mentioned disadvantages of the heretofore-known methods of this general type, which provides an improvement over the prior art and which, in particular, provides a cost-efficient way of manufacturing high-quality products with high-end special-effect finishes and an improved impact of the special effects.

With the foregoing and other objects in view there is provided, in accordance with the invention, a method of manufacturing printed products, which includes the steps of providing a printing substrate, providing a first fluid and applying the first fluid to the printing substrate as a first layer, providing an effect fluid as a second fluid, the effect fluid including a carrier fluid and platelet-shaped effect pigments, and applying the effect fluid to the printing substrate as a second layer, the second layer forming an effect layer, and creating the first layer as a duct layer having a plurality of ducts, the ducts allowing at least a portion of the carrier fluid of the effect fluid to pass through or to enter, and the ducts substantially not allowing the effect pigments of the effect fluid to pass through or enter.

Advantageous and thus preferred further developments of the invention will become apparent from the dependent claims as well as from the description and drawings.

### ADVANTAGEOUS EMBODIMENTS AND EFFECTS OF THE INVENTION

The invention provides a cost-efficient and thus advantageous way of creating high-quality printed products with a high-end finish with special effects and an improved impact of the special effects.

The duct layer may act on the carrier fluid like a sieve or strainer, i.e. it may advantageously remove at least a portion of the carrier from the effect layer. A portion of the carrier fluid may pass through the ducts and may be absorbed by the printing substrate, which is preferably absorbent. The duct layer may thus advantageously act as drainage. This may in turn advantageously cause the effect pigments to align substantially in parallel with the plane of the effect layer in the remaining carrier fluid due to steric effects, thus improving the effect to be achieved, e.g. glossiness. Moreover, the consumption of effect fluid may be reduced.

The thickness of the duct layer and/or the dimensions of the ducts, the carrier liquid, and the absorbency of the printing substrate (or of an optional absorption layer) in terms of the carrier liquid may thus be adapted to one another in such a way that an advantageous portion of the carrier liquid is removed from the effect layer. The portion is considered advantageous if the generated effect layer, which has been dried and/or cured as desired, has a high degree of effect pigments that have aligned in a plane-parallel way and is thick enough to protect the included effect pigments at the same time, for instance from abrasion.

Since common printing substrates such as paper have a certain roughness (which may be detrimental to a desired gloss effect of the effect layer), the duct layer may advantageously have a smoother surface than the printing substrate. Such a smooth surface may, for instance, improve a desired gloss effect of the effect layer.

The first fluid may be printing ink or printing varnish, for instance oilbased offset ink. The second fluid may likewise be printing ink or printing varnish, preferably water-based varnish such as so-called dispersion varnish.

The printing substrate is preferably paper, cardboard, or a metal or plastic foil, and it may be provided in sheet or web form. Thus the printing substrate is preferably flat and very thin. Alternatively, the printing substrate may be of thicker material, for instance of wood or a ceramic material. Therefore, applications in the furniture industry or in decorative printing are conceivable.

The platelets, i.e. the platelet-shaped effect pigments, are shaped like plates, preferably like small and flat plates and are particularly in micrometer range.

### FURTHER DEVELOPMENTS OF THE INVENTION

The following paragraphs describe preferred further developments of the invention.

A further development may be characterized in that the ducts are generated as continuous ducts which pass through the first layer. An alternative further development may be characterized in that the ducts are generated as ducts which terminate in the first layer. The ducts may be configured as straight ducts which pass through the duct layer in a substantially perpendicular direction. The ducts may branch off or may not branch off. The ducts may be formed by interconnected pores, i.e. the duct layer may be porous, in particular with open pores.

A further development may be characterized in that the ducts are generated when the first fluid is applied. Thus an open layer with ducts is generated. An alternative further development may be characterized in that the ducts are generated after the first fluid has been applied. Thus a closed layer without ducts is generated in a first step.

A further development may be characterized in that the ducts are disposed as a periodic pattern. The pattern may be of a checkered type. An alternative further development may be characterized in that the ducts are disposed as a random pattern. The proportion the openings make up of the total surface of the duct layer may range between 20 and 40%, preferably between 25 and 35%, in particular at approximately 30%. The pattern may be created by using an offset printing forme, for instance with an open offset screen.

A further development may be characterized in that ducts are generated whose opening dimension is smaller than the platelet dimension of the effect pigments. For instance, for ducts with a circular cross-section, the opening dimension would preferably be the diameter of the duct. For ducts with any cross-section, the opening dimension may for instance be the largest (inner) dimension of the duct opening. For instance, for effect pigments with a circular cross-section, the platelet dimension would preferably be their diameter (or average of the diameters). For platelets with any cross-section, the platelet dimension may for instance be the largest dimension of the platelets (in the plane of the platelets).

A further development may be characterized in that the duct layer is smoothed. A special further development may be characterized in that the smoothing is done by using a smooth foil. The smoothing may be done in a foil unit of an offset printing press. A special further development may be characterized in that the smoothing is done in a cast-and-cure process. In this process, a smooth foil and preferably UV radiation may be used. Since the ducts may narrow during the curing process under the influence of UV radiation, the ducts are preferably initially generated to have a greater opening diameter to ensure that after the curing process, the ducts have the required opening dimensions. An advantage of the smoothing step may be that even for very absorbent printing substrates, a moderate amount of effect fluid will be sufficient.

A further development may be characterized in that the duct layer may be generated by printing. A further development may be characterized in that the duct layer may be generated by using a printing forme. A special embodiment may be characterized in that the duct layer is generated in a flexographic printing operation, for instance using UV varnish. A likewise special further development may be characterized in that the duct layer is generated in an offset printing operation.

A further development may be characterized in that a printing forme is used which has a screen structuring the duct layer with ducts. The screen may be a flexographic screen or an offset screen.

A further development may be characterized in that the duct layer is generated without any printing forme. A special further development may be characterized in that the duct layer is generated in an inkjet printing operation. An alternative further development may be characterized in that the duct layer is generated by spraying. The spraying is preferably done in such a way that no closed layer but an open layer is generated.

A further development may be characterized in that the effect layer is generated in a printing operation. A further development may be characterized in that the effect layer is generated by using a printing forme. A special further development may be characterized in that the effect layer is generated in a flexographic printing operation. A likewise special further development may be characterized in that the effect layer is generated in a gravure or screen printing process. A gravure process usually uses very thin liquid printing inks of low viscosity; this may be advantageous when the effect layer is created. An alternative further development may be characterized in that the effect layer is generated without the use of a printing forme. A special further development may be characterized in that the effect layer is generated by spraying. The spraying is preferably done in such a way that a closed layer is created.

A further development may be characterized in that the ducts are generated in an optical process. A special further development may be characterized in that the generation of the ducts involves the use of laser light. It is possible initially to create the first layer as a closed layer and to introduce ducts into the closed layer by using laser light.

A further development may be characterized in that the ducts are generated in a mechanical way. It is possible to use needles, for instance using a needle roller or needle bed, to generate the ducts.

A further development may be characterized in that an absorption layer accepting and/or absorbing the carrier fluid is applied to the printing substrate. The thickness of the absorption layer may preferably be up to 5 or 10 µm. The absorption layer may be porous and thus absorb carrier fluid. The absorption layer may include a silicate-containing material. A special further development may be characterized in that the duct layer is applied to the absorption layer. A likewise special further development may be characterized in that the effect layer is applied to the duct layer. The absorption layer, the duct layer, and the effect layer may thus form a succession of layers. After its application, the absorption layer may be dried and/or cured. The drying and/or curing may be done in such a way that pores form in the absorption layer.

A further development may be characterized in that a glazing fluid is applied to the effect layer a as a further layer. The glazing fluid may be a printing ink. In this way, for instance an effect layer with a metallic gloss may additionally receive a hue. More than one further layer may be applied, for instance four layers in a four-color printing operation. The further layer or further layers may have a screen.

A further development may be characterized in that a protective layer is applied to the effect layer or to the further layer. The protective layer may be a so-called top coat. The protective layer may be a clear varnish.

A further development may be characterized in that the effect pigments are metallic effect pigments. A special further development may be characterized in that the effect pigments are aluminum-based. The platelet dimensions of the metallic effect pigments may be between 8 and 18 µm.

A further development may be characterized in that the effect pigments are interference pigments. The interference pigments may for instance, be mica-based or silicate-based or glass platelet-based (also known as glass flakes). For instance, so-called iriodines may be utilized. The platelet dimensions of the interference pigments may range between 10 and 200 µm, preferably between 25 and 50 µm. The effect pigments may be electrically conductive and may include graphite for this purpose.

A further development may be characterized in that with respect to the carrier fluid, the effect pigments are non-leafing pigments i.e. they preferably do not rise to the surface of the carrier fluid. Such pigments are called non-leafing pigments, in contrast to leafing pigments which rise to the surface of the carrier fluid and stay there.

A further development may be characterized in that the effect fluid is a water-based varnish. It may be a water-based suspension.

A further development may be characterized in that the printed product is dried and/or cured. The printed product may be treated with all its layers. A special further development may be characterized in that the duct layer and/or the effect layer and/or a further layer and/or a protective layer is dried and/or cured. In this process, individual layers may be treated or two or more layers may be treated together. The drying may be achieved by infrared radiation. The curing may be achieved by UV radiation.

Any desired combination of the features and combinations of features disclosed in the above sections on the technical field, invention, and further developments as well as in the section below on exemplary embodiments, likewise represents advantageous further developments of the invention.

Other features which are considered as characteristic for the invention are set forth in the appended claims.

Although the invention is illustrated and described herein as embodied in a method of creating a printed product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIGS. 1A, 1B and 1C are diagrammatic, cross-sectional views of a substrate and a layer according to the prior art;

FIGS. 2A and 2B are cross-sectional views of a substrate and a layer according to a preferred exemplary embodiment of the invention;

FIGS. 3A and 3B are cross-sectional views of a substrate and a layer according to a further preferred exemplary embodiment of the invention;

FIG. 4 is a flow chart of a preferred exemplary embodiment of the invention;

FIG. 5 is a block diagram illustrating a printing machine implementing the invention; and

FIG. 6 is a fragmentary, top-plan view of a duct layer in accordance with the invention.

### DETAILED DESCRIPTION OF THE INVENTION

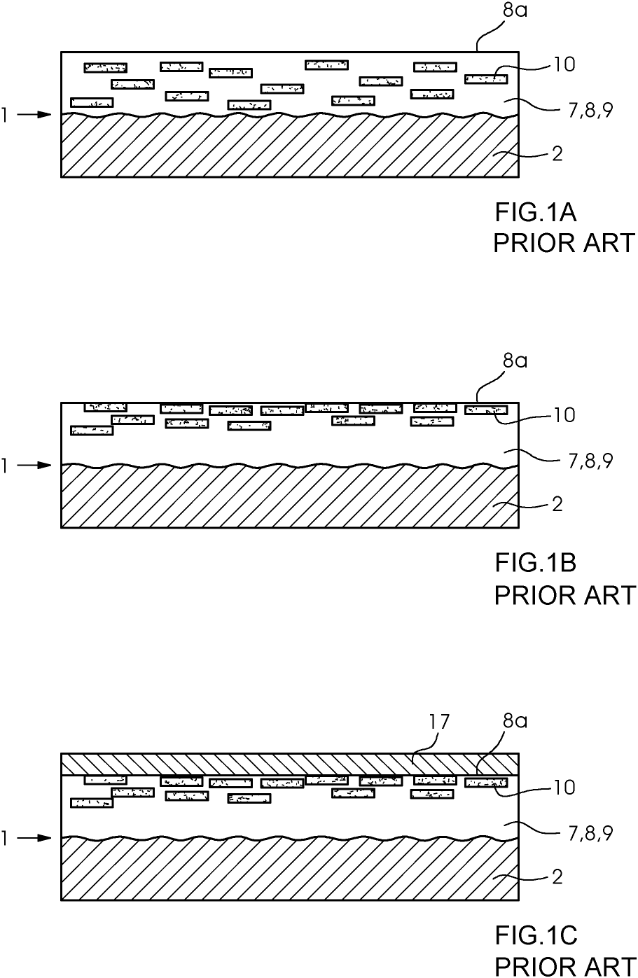

Referring now in detail to the figures of the drawings, in which corresponding features have the same reference symbols and repetitive reference symbols have sometimes been left out for reasons of visibility, and first, particularly, to FIGS. 1A, 1B, and 1C thereof, there is seen an illustration of the prior art. A fluid 7 has been applied to a printing substrate 2 as a layer 8. The fluid 7 includes a carrier fluid 9 and platelet-shaped effect pigments 10 included therein. The pigments 10 are leafing pigments, i.e. they accumulate on the surface 8a of the carrier fluid, which has not yet been dried or cured. A protective layer 17 is provided to protect the pigments 10 against being scratched off the surface in an undesired way.

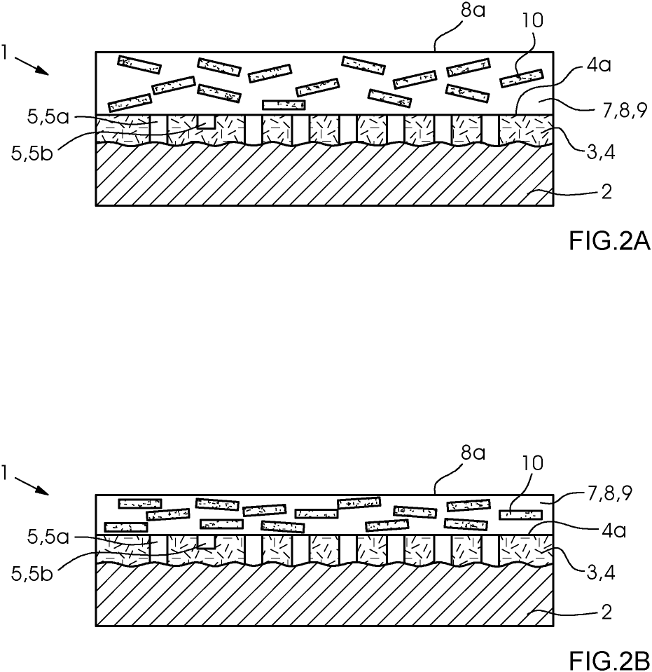

The embodiment of the invention shown in FIGS. 2A and 2B, i.e. the illustrated succession of layers provided by a method of the invention, illustrates a printed product 1 including a printing substrate 2, for instance paper, cardboard, or foil. A first fluid 3 has been applied to the printing substrate as a first layer 4. The first layer includes ducts 5, preferably continuous ducts 5a that pass through the entire layer, alternatively blind ducts 5b (only one such duct is shown by way of example). The first layer has a surface 4a. A second fluid 7 has been applied to the surface 4a as a so-called effect fluid. The second fluid forms a second layer 8, which is known as an effect layer. The effect layer 8 includes a carrier fluid 9 and preferably platelet-shaped effect pigments 10 included therein. The effect pigments are non-leafing pigments which do not accumulate on the surface 8a of the effect layer but preferably remain homogeneously distributed within the carrier fluid.

A comparison between FIGS. 2A and 2B reveals that the effect layer 8 has lost carrier fluid 9. The ducts 5 are made in such a way that they allow at least a portion of the carrier fluid to get into the ducts and/or preferably to pass through them. In the illustrated example, a portion of the carrier fluid has passed through the ducts and has thus reached the printing substrate 2. Since the printing substrate has a suction effect on the carrier fluid, the latter penetrates into the printing substrate, i.e. it is absorbed by the printing substrate. This process reduces the thickness of the effect layer, causing the effect pigments 10 to move closer to one another and to preferably orient themselves to be plane-parallel to one another and to the plane of the effect layer. This improves the desired effect, for instance a gloss effect, created by the effect pigments in the effect layer.

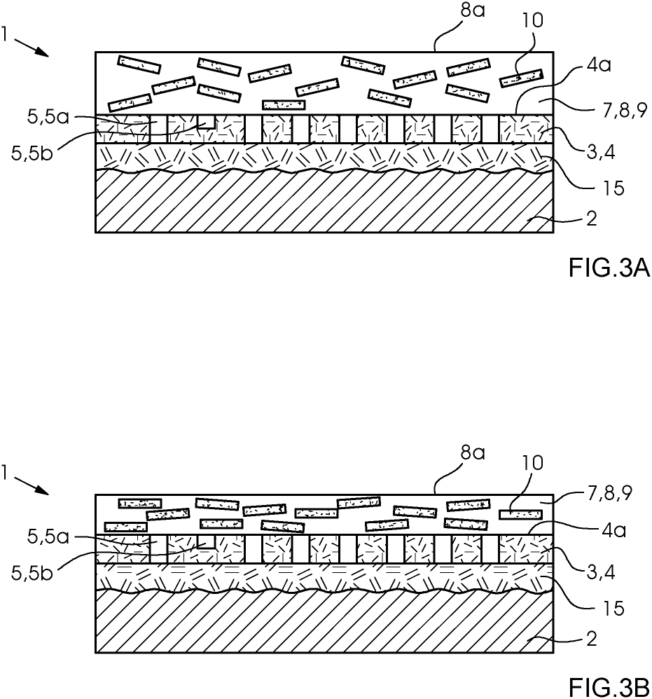

The further embodiments of the invention shown in FIGS. 3A and 3B are substantially similar to the embodiment described above. However, an absorption layer 15 that has been applied to the printing substrate 2 in a first step is visible. The effect layer 8 has been applied to the surface of the absorption layer. The absorption layer has a suction effect on the carrier fluid 9. Thus at least a portion of the carrier fluid passes through the ducts 5 into the absorption layer and is absorbed by the latter. Therefore, this embodiment is advantageous when non-absorptive printing substrates 2 are used.

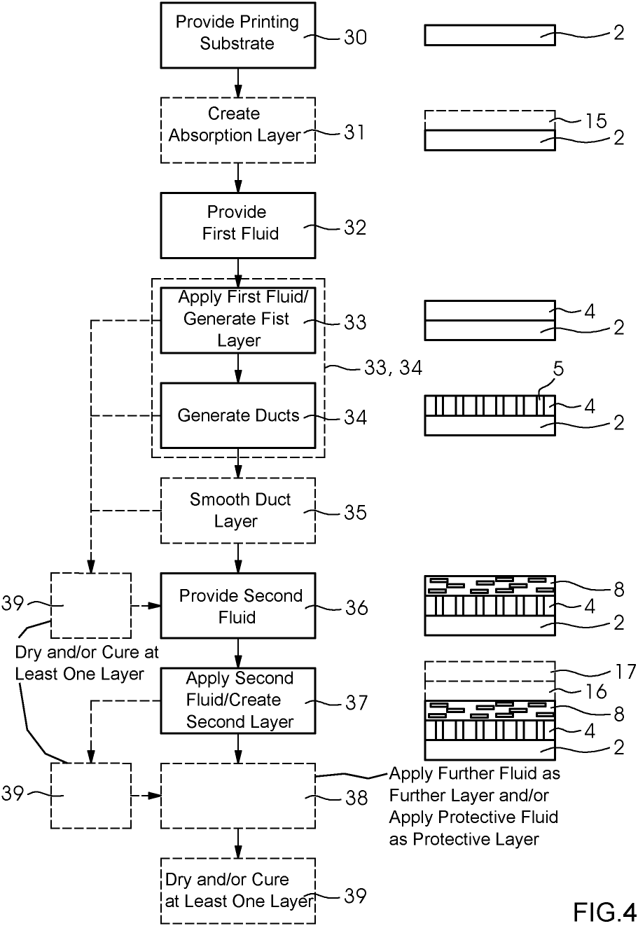

The flow chart shown in FIG. 4 illustrates the following steps of a preferred embodiment of the method of the invention:
Step 30: providing the printing substrate 2.
Optional step 31: creating the absorption layer 15.
Step 32: providing the first fluid 3.
Step 33: applying the first fluid 3/generating the first layer 4, i.e. the duct layer.
Step 34: generating ducts 5.
   Steps 33 and 34 may preferably be combined to form a single step, i.e. the ducts 5 are generated when the first fluid 3 is applied.
Optional step 35: smoothing the duct layer 4.
Step 36: providing the second fluid 7.
Step 37: applying the second fluid 7/creating the second layer 8, i.e. the effect layer.
Optional step 38: applying a further fluid as a further layer 16 and/or applying a protective fluid as a protective layer 17.
Optional step 39: drying and/or curing one layer, some of the layers, or all layers. Step 39 may be done as the last step. Step 39 may be done as an alternative or in addition to any one of steps 33, 34, or 35 and before step 36 and/or after step 37 and before step 38.

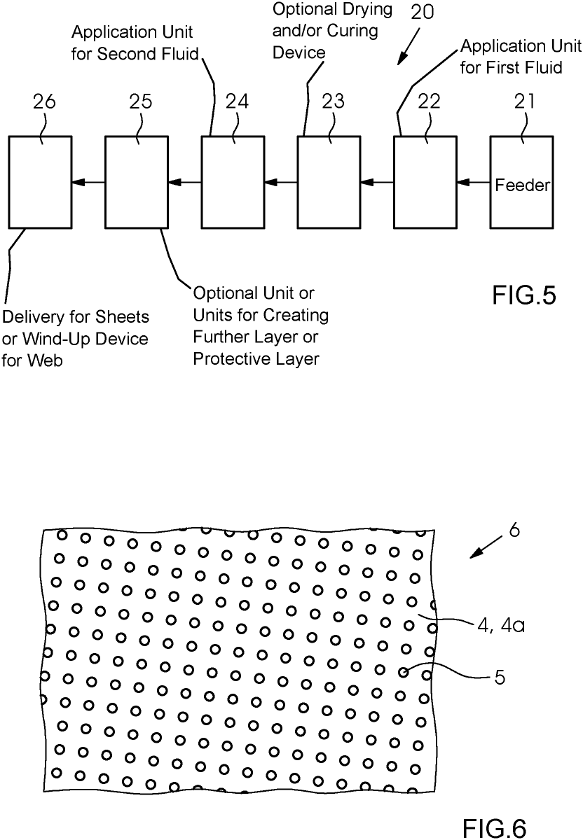

FIG. 5 illustrates a printing machine 20 for implementing a method of the invention. From left to right, the printing machine includes the following elements:
a feeder 21 for sheets of a printing substrate or an unwinding device 21 for a web of a printing substrate;
an application unit 22 which provides the first fluid 3 and creates the first layer 4. The application unit 22 preferably also creates the ducts 5. Optionally, a unit for creating the absorption layer 15 may be provided upstream of the application unit 22;
an optional drying and/or curing device 23 for the first layer 4;
an application unit 24 which provides the second fluid 7 and creates the second layer 8;
an optional unit or multiple optional units 25 which create at least one further layer 16 and/or a protective layer 17. It takes a certain amount of time for the printing substrate 2 to pass through this unit/these units; in the meantime, the carrier fluid 9 may pass through the ducts 5 before an optional drying/curing process sets in if desired (forming a process path); and
a delivery 26 for sheets of printing substrate or a wind-up device for web of printing substrate.

The printing machine 20 may be followed by a machine for the further processing of printed products, for instance a cutting device and/or a folding device.

FIG. 6 is a top view of the first layer/the duct layer 4. The ducts 5 in the surface 4a of the duct layer are clearly visible. In the illustrated example, the ducts form a regular pattern 6.

The following is a summary list of reference numerals and the corresponding structure used in the above description of the invention.

List of Reference Symbols:

| | |
|---|---|
| 1 | printed product |
| 2 | printing substrate |
| 3 | first fluid |
| 4 | first layer/duct layer |
| 4 a | surface of first layer |
| 5 | ducts |
| 5 a | continuous ducts |
| 5 b | blind ducts |
| 6 | screen |
| 7 | second fluid/effect fluid |
| 8 | second layer/effect layer |
| 8 a | surface of second layer |
| 9 | carrier fluid |
| 10 | platelet-shaped effect pigments |
| 15 | optional absorption layer |
| 16 | optional further layer |
| 17 | optional protective layer |
| 20 | printing machine |
| 21 | feeder/unwinding device |
| 22 | application unit for first layer |
| 23 | optional drying/curing device |
| 24 | application unit for second layer |
| 25 | optional units, optional drying/curing device |
| 26 | delivery/wind-up device |
| 30 | providing printing substrate |
| 31 | optionally creating absorption layer |
| 32 | providing first fluid |
| 33 | applying first fluid/creating first layer |
| 34 | creating ducts |
| 35 | optionally smoothing the duct layer |
| 36 | providing second fluid |
| 37 | applying second fluid/creating second layer |
| 38 | optionally applying (further layer and/or protective layer) |
| 39 | optionally drying/curing |

1. A method of creating a printed product, the method comprising:
providing a printing substrate;
providing a first fluid and applying the first fluid to the printing substrate as a first layer;
providing an effect fluid as a second fluid, the effect fluid including a carrier fluid and platelet-shaped effect pigments, and applying the effect fluid to the printing substrate as a second layer, the second layer forming an effect layer; and
creating the first layer as a duct layer having a multiplicity of ducts, the ducts allowing at least a portion of the carrier fluid of the effect fluid to pass through or to enter, and the ducts substantially not allowing the effect pigments of the effect fluid to pass through or enter.

2. The method according to claim 1, which further comprises creating the ducts as ducts passing through the first layer.

3. The method according to claim 1, which further comprises creating the ducts as ducts terminating in the first layer.

4. The method according to claim 1, which further comprises creating the ducts when the first fluid is applied.

5. The method according to claim 1, which further comprises creating the ducts after the first fluid has been applied.

6. The method according to claim 1, which further comprises smoothing the duct layer.

7. The method according to claim 1, which further comprises applying an absorption layer to the printing substrate, the absorption layer at least one of accepting or absorbing the carrier fluid.

8. The method according to claim 1, which further comprises providing the effect pigments as non-leafing pigments relative to the carrier fluid.

9. The method according to claim 1, which further comprises at least one of drying or curing the printed product.

10. The method according to claim 1, which further comprises at least one of drying or curing at least one of:
the duct layer,
the effect layer,
a further layer, or
a protective layer.
